(19) United States
(12) Patent Application Publication
(10) Pub. No.: US 2021/0387523 A1
(43) Pub. Date: Dec. 16, 2021

(54) REACTION FORCE CONTROL SYSTEM FOR PEDAL

(71) Applicant: TOYOTA JIDOSHA KABUSHIKI KAISHA, Toyota-shi, Aichi (JP)

(72) Inventors: Shuntaro SHINOHARA, Toyota-shi (JP); Hideaki OTSUBO, Toyota-shi (JP); Hiromitsu METSUGI, Toyota-shi (JP); Yoichiro ISAMI, Toyota-shi (JP); Hiroyasu KITAGAWA, Toyota-shi (JP); Takuya HIRATA, Toyota-shi (JP)

(73) Assignee: TOYOTA JIDOSHA KABUSHIKI KAISHA, Toyota-shi, Aichi (JP)

(21) Appl. No.: 17/284,851

(22) PCT Filed: Nov. 29, 2019
(86) PCT No.: PCT/JP2019/046800

§ 371 Date: Apr. 13, 2021

(30) Foreign Application Priority Data
Dec. 11, 2018 (JP) 2018-231406

(51) Int. Cl. B60K 26/02; B60T 7/06

(52) U.S. Cl. CPC B60K 26/021; B60K 2026/022; B60T 7/06

(57) ABSTRACT

A reaction force control system for a pedal that is configured to stably operate a vehicle in which an operating mode can be shifted between normal and one-pedal modes, without requiring a complicated operation, and without disturbing a driver. An operating mode is selected from a one-pedal mode in which a drive force and a brake force are controlled by manipulating an accelerator pedal, and a normal mode in which drive force is controlled by manipulating the accelerator pedal, and the brake force is controlled by manipulating the brake pedal. Reaction force applied to the accelerator pedal is increased for a predetermined period of time when shifting from one of the operating modes to the other one, and thereafter the reaction force is adjusted in accordance with a position of the accelerator pedal in the other one of the operating modes.

### TECHNICAL FIELD

The present invention relates to a control system for controlling not only a drive force but also a brake force applied to a vehicle in response to an operation of a common pedal (one-pedal mode), and especially to a control system for controlling a reaction force against a pedal force applied to the pedal.

### BACKGROUND ART

Systems of this kind are described in Patent Documents 1 and 2. Patent Document 1 describes an acceleration/deceleration controller configured to establish a one-pedal mode in which a vehicle is accelerated and decelerated in accordance with an operating amount of a common pedal. According to the teachings of Patent Document 1, specifically, a position range of the pedal is divided into an accelerating range and a decelerating range. That is, the vehicle is accelerated if the pedal is positioned within the accelerating range, and decelerated if the pedal is positioned within the decelerating range. In addition, according to the teachings of Patent Document 1, an operating mode may be shifted between the one-pedal mode and a normal mode in which the vehicle is accelerated in accordance with an operating amount of an accelerator pedal and decelerated in accordance with an operating amount of a brake pedal. When the operating mode is shifted from the normal mode to the one-pedal mode, the controller notifies a driver that the operating mode has been shifted to the one-pedal mode phonically by a voice message or visually by a text message indicated e.g., on a display of a navigation system. In the controller taught by Patent Document 1, the operating mode can be switched between the one-pedal mode and the normal mode by manipulating a switch arranged in an instrument panel.

Patent Document 2 also describes a travel control device of vehicle configured to shift an operating mode between the one-pedal mode and the normal mode. Specifically, the travel control device taught by Patent Document 2 is configured to reduce uncomfortable feeling of a driver due to changes in acceleration and deceleration resulting from changing the operating mode from the normal mode to the one-pedal mode. To this end, a pedal stroke amount is increased by reducing a reaction force against a pedal force applied to a pedal when shifting the operating mode from the normal mode to the one-pedal mode. For this reason, a pedal operation is assisted so that changes in acceleration and deceleration can be reduced before and after the mode change.

Patent Document 3 describes a vehicular driving operation auxiliary unit configured to shift an operating mode between an automatic control mode in which a vehicle follows a preceding vehicle while maintaining a predetermined distance, and a manual control mode in which the vehicle is propelled by manipulating an accelerator pedal. In order to allow a driver to easily recognize a mode change between the automatic control mode and the manual control mode, the unit taught by Patent Document 3 changes a vehicle behavior in the event of the mode change. For example, the driver is notified of a fact that the operating mode is changed by temporarily shifting a gear stage of an automatic transmission. In addition, the driver may also be notified of a fact that the operating mode is changed by changing a reaction force against a pedal force applied to an accelerator pedal.

### PRIOR ART DOCUMENT

### Patent Literature

Patent Document 1: JP 2006-175944 A.

Patent Document 2: JP 2013-217242 A.

Patent Document 3: JP 2009-161180 A.

### SUMMARY OF INVENTION

### Technical Problem to be Solved by the Invention

Thus, the devices configured to select the operating mode from a plurality of mode in which the drive force or brake force generated with respect to an operating amount of the pedal is different are known in the art. According to the conventional art, the driver is notified of a mode change phonically (acoustically) or optically (visually). However, the driver may not perceive such notification depending on a travelling condition. For example, if external noise is too loud or if the driver has a conversation while driving, the driver may not perceive the notification of the mode change. In addition, the driver may not be allowed to look at the display of the navigation system depending on a travelling condition. In those cases, the driver may not sense an execution of the mode change, and as a result, the driver may depress the pedal unnecessarily deeply.

In addition, according to the teachings of Patent Document 1, the position range of the pedal in the one-pedal mode is divided into the accelerating range and the decelerating range. That is, drive characteristics in the one-pedal mode are deferent from drive characteristics in the normal mode in which the entire position range of the pedal is the accelerating range. Therefore, if, for example, the operating mode is shifted from the one-pedal mode to the normal mode while maintaining the position of the pedal (or without changing a stroke of the pedal), the drive force would be increased unintentionally to disturb the driver. Thus, the control to operate the vehicle in which the operating mode can be shifted between the one-pedal mode and the normal mode has to be improved to operate the vehicle in a stable manner.

The present invention has been conceived noting the foregoing technical problems, and it is therefore an object of the present invention to provide a reaction force control system for a pedal that is configured to stably operate a vehicle in which an operating mode can be shifted between a normal mode and a one-pedal mode, without requiring a complicated operation, and without disturbing a driver.

### Means for Solving the Problem

The reaction force control system for a pedal according to the present invention comprises: an accelerator pedal of a vehicle that is operated by a driver; a brake pedal that is operated by the driver; and a reaction force generating mechanism that applies a reaction force to the accelerator pedal against a pedal force applied to the accelerator pedal, and that changes the reaction force. The reaction force control system is configured to select an operating mode from: a one-pedal mode in which not only a drive force but also a brake force are controlled by manipulating the accelerator pedal; and a normal mode in which the drive force is controlled by manipulating the accelerator pedal, and the brake force is controlled by manipulating the brake pedal. In order to achieve the above-explained objective, according to the present invention, the reaction force control system is provided with a controller that controls the reaction force applied to the accelerator pedal. The controller is configured to increase the reaction force applied to the accelerator pedal for a predetermined period of time when shifting the operating mode from one of the one-pedal mode and the normal mode to the other one of the operating modes, and thereafter adjust the reaction force in accordance with a position of the accelerator pedal in the other one of the operating modes.

According to the present invention, the controller may be further configured to increase the reaction force applied to the accelerator pedal for the predetermined period of time, and thereafter reduce the reaction force gradually in accordance with the position of the accelerator pedal in the other one of the operating modes.

According to the present invention, the controller may be further is configured to increase and reduce the reaction force repeatedly thereby vibrating the accelerator pedal.

According to the present invention, the reaction force may be controlled to vibrate the accelerator pedal at a magnitude sufficient to urge the driver to lift his/her foot off the accelerator pedal.

According to the present invention, the controller may be further configured to increase the reaction force to push back the foot of the driver on the accelerator pedal toward an idle position so as to urge the driver to lift his/her foot off the accelerator pedal, when increasing the reaction force for the predetermined period of time in the event of a mode change from the one-pedal mode to the normal mode.

### Advantageous Effects of Invention

The reaction force control system for the pedal according to the present invention is configured to increase the reaction force applied to the accelerator pedal for the predetermined period of time when shifting the operating mode from one of the one-pedal mode and the normal mode to the other one of the one-pedal mode and the normal mode. Specifically, when shifting the operating mode, the reaction force is increased and reduced repeatedly to vibrate the accelerator pedal. That is, the driver is notified of the fact that the operating mode has been shifted by the vibrations of the accelerator pedal. For this reason, the driver is allowed to certainly recognize the fact that the operating mode has been shifted between the one-pedal mode and the normal mode. In addition, since the driver can be certainly notified of the execution of the mode change, the driver will not depress the accelerator pedal 2 unnecessarily deeply after shifting the operating mode from the one-pedal mode to the normal mode. Since the accelerator pedal will not be unnecessarily deeply, the drive force can be generated in line with the intension of the driver. For this reason, the driver can be prevented from being upset and disturbed.

In addition, according to the present invention, the driver may be physically notified of the execution of the mode change by the change in the reaction force applied to the accelerator pedal. Therefore, the driver is allowed to recognize an execution of the mode change more certainly compared to the case of notifying the driver acoustically or visually as taught by Patent Document 1.

Further, according to the present invention, the reaction force applied to the accelerator pedal is increased for the predetermined period of time, and thereafter adjusted in accordance with the position of the accelerator pedal in the normal mode. In the one-pedal mode, the range of movement of the accelerator pedal is divided into a decelerating range and an accelerating range. Whereas, in the normal mode, an entire position range of the accelerator pedal is the accelerating range. That is, the drive force established with respect to a predetermined operating amount of the accelerator pedal is changed between the one-pedal mode and the normal mode. Therefore, the driver may depress the accelerator pedal unnecessarily deeply when the operating mode is shifted from the one-pedal mode to the normal mode. Nonetheless, according to the present invention, the reaction force applied to the accelerator pedal is temporarily increased to push back the foot of the driver on the accelerator pedal toward the idle position. Therefore, the driver is certainly notified of execution of the mode change by such increase in the reaction force so that the driver is allowed to operate the accelerator pedal properly.

Furthermore, according to the present invention, the reaction force applied to the accelerator pedal is increased temporarily to push back the foot of the driver on the accelerator pedal toward the idle position and to urge the driver to lift his/her foot off the accelerator pedal. Since the driver is urged to lift his/her foot off the accelerator pedal, a position of the accelerator pedal can be adjusted to an appropriate position in the normal mode. Therefore, when the driver puts his/her foot on the accelerator pedal again, the driver is allowed to operate the accelerator pedal without being disturbed.

### BRIEF DESCRIPTION OF DRAWINGS

FIG. 1 is a schematic illustration showing one example of a structure of an accelerator pedal to which the present invention is applied.

FIG. 2 is a graph indicating characteristics of a reaction force applied to the accelerator pedal in the one-pedal mode;

FIG. 3 is a flowchart showing one example of a routine executed by the reaction force control system according to the present invention;

FIG. 4 is a time chart showing one example of a temporal change in a position of the accelerator pedal and the reaction force applied to the accelerator pedal when shifting the operating mode from the normal mode to the one-pedal mode.

FIG. 5 is a graph indicating characteristics of the reaction force applied to the accelerator pedal in the example shown in FIG. 4.

FIG. 6 is a time chart showing another example of a temporal change in a position of the accelerator pedal and the reaction force applied to the accelerator pedal when shifting the operating mode from the normal mode to the one-pedal mode.

FIG. 7 is a graph indicating characteristics of the reaction force applied to the accelerator pedal in the example shown in FIG. 6.

### DESCRIPTION OF EMBODIMENTS(s)

Embodiments of the present invention will now be explained with reference to the accompanying drawings. Note that the embodiments shown below are merely examples the present invention, and do not limit the present invention.

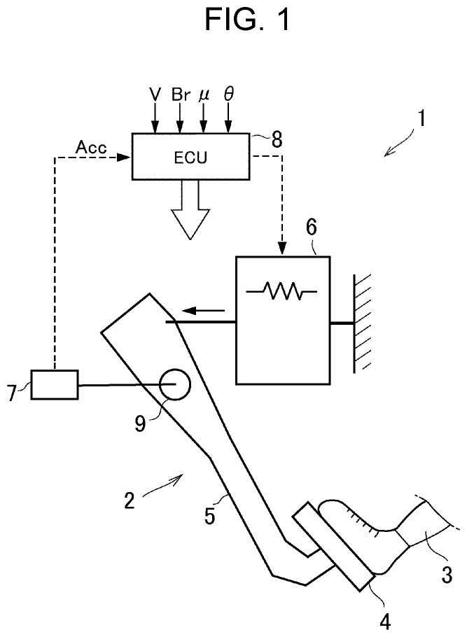

The present invention is applied to a vehicle comprising an accelerator pedal and a brake pedal, and the vehicle is accelerated and decelerated by depressing and returning those pedals. Turning now to FIG. 1, there is shown one example of a structure of an accelerator mechanism (or an accelerator device) 1 including an accelerator pedal 2. The accelerator pedal 2 comprises a pedal arm 5, and a pedal pad 4 attached to the pedal arm 5 to receive a pedal force applied from a driver 3. The pedal arm 5 is pivoted (or reciprocated) in a longitudinal direction of the vehicle when the accelerator pedal 2 is depressed by the driver 3. In order to return the depressed accelerator pedal 2 to an idle position, and to establish a reaction force against the pedal force applied by the driver 3, the accelerator mechanism 1 is provided with a reaction force generating mechanism 6. The accelerator mechanism 1 shown in FIG. 1 further comprises an accelerator position sensor 7, and a controller (ECU) 8. For example, the accelerator mechanism 1 shown in FIG. 1 may be applied to a vehicle in which an engine serves as a prime mover, a hybrid vehicle in which a prime mover includes an engine and a motor, and an electric vehicle in which a motor serves as a prime mover (neither of which are shown).

The accelerator pedal 2 is an operating device that is depressed and returned by the driver 3 to control a drive force to propel the vehicle. Specifically, a drive force generated by the prime mover, that is, an engine torque or a motor torque is changed in accordance with an operating amount or a depression (i.e., a stroke) of the accelerator pedal 2. As described, the accelerator pedal 2 comprises the pedal pad 4 and the pedal arm 5. Specifically, the pedal arm 5 is suspended from a fulcrum (or shaft) 9 toward a not shown floor in such a manner as to pivot about the fulcrum 9, and the pedal pad 4 is attached to a lower end of the pedal arm 5.

An operating amount (or a position) and an operating speed of the accelerator pedal 2 is detected by the accelerator position sensor 7. For example, the accelerator position sensor 7 detects an angle of the pedal arm 5 from the idle position when the pedal force is applied to or reduced from the pedal pad 4 by the driver 3. Instead, a pedal force sensor may also be adopted to detect a pedal force applied to the pedal pad 4. In addition, the accelerator position sensor 7 transmits a detection signal of an operating amount of the accelerator pedal 2. Specifically, accelerator pedal 2 is so-called a “haptic pedal” adapted to provide the driver 3 with some form of feedback information by means of vibrations or a force.

The reaction force generating mechanism 6 generates a reaction force against the pedal force applied to the pedal pad 4, and according to the example shown in FIG. 1, a magnitude of the reaction force is changeable and adjustable. Specifically, the reaction force generating mechanism 6 is provided with an actuator (e.g., a motor), and the reaction force generating mechanism 6 generates and adjusts the reaction force in accordance with a position of the accelerator pedal 2 by controlling the actuator. In order to return the accelerator pedal 2 to the idle position, the reaction force generating mechanism 6 is further provided with a return spring.

The controller 8 is an electronic control unit (ECU) that controls the prime mover (not shown) such as an engine and a motor and the reaction force generating mechanism 6, based on incident signals transmitted from various kind of sensors. The controller 8 comprises a microcomputer configured to execute a calculation based on the incident signals and data installed in advance, and to transmit a calculation result in the form of command signal. To this end, for example, the controller 8 receives detection data about a position (or an operating amount) Acc of the accelerator pedal 2 detected by the accelerator position sensor 7, a vehicle speed V, a brake signal Br transmitted when a brake pedal is depressed, a friction coefficient μ, a road gradient θ, unevenness of the road surface and so on. For example, the data installed in the controller 8 includes a map determining characteristics of the drive force, and a map determining characteristics of the reaction force applied to the accelerator pedal 2. The controller 8 transmits command signals for controlling the prime mover, the reaction force generating mechanism 6, and so on. Specifically, an actuating amount of the actuator is controlled in accordance with the operating amount of the accelerator pedal 2.

According to the embodiment of present invention, the vehicle may be propelled in the one-pedal mode in which not only the drive force but also the brake force (i.e., acceleration and deceleration) are changed in accordance with an operating amount of the accelerator pedal 2. As the conventional vehicles, the vehicle to which the accelerator mechanism 1 is applied comprises the accelerator pedal 2 and the brake pedal (not shown). Therefore, the vehicle may also be propelled (in a normal mode) while controlling the drive force and the brake force based on operating amounts of the accelerator pedal 2 and the brake pedal. Thus, an operating mode of the vehicle may be selected from the one-pedal mode and the normal mode. For example, the operating mode may be changed by manipulating an operating switch arranged in an instrument panel or steering wheel. Instead, the operating mode may also be changed by manipulating a button or lever, or by a voice recognition system.

Here will be explained the one-pedal mode in more detail. In the one-pedal mode, the vehicle is accelerated and decelerated by manipulating only the accelerator pedal 2. Specifically, in the vehicle according to the embodiment of the present invention, a range of movement of the accelerator pedal 2 is divided into a decelerating range which is set in a relatively shallow range of movement (or stroke) of the accelerator pedal 2, and an accelerating range which is set in a relatively deep range of movement of the accelerator pedal 2, across a reference range (i.e., a zero-torque range). Specifically, a range from an initial position of the accelerator pedal 2 to the reference range is the decelerating range. Given that the accelerator pedal 2 is positioned within the decelerating range, the brake force applied to the vehicle is increased with a reduction in depression of the accelerator pedal 2. On the other hand, a range from the reference range to a deepest position of the accelerator pedal 2 is the accelerating range. Given that the accelerator pedal 2 is positioned within the accelerating range, a drive force to propel the vehicle is increased with an increase in depression of the accelerator pedal 2. Specifically, the deepest position (i.e., a stroke end) of the accelerator pedal 2 is a position at which the accelerator pedal 2 is depressed completely, and a degree of depression of the accelerator pedal 2 at the deepest position may be expressed as a 100% depression.

Thus, in the accelerating range of the one-pedal mode, the accelerator pedal 2 serves as an accelerator pedal (of the conventional vehicles) in the normal mode. That is, in the accelerating range, the drive force to propel the vehicle is increased with an increase in an operating amount of the accelerator pedal 2.

Whereas, in the decelerating range of the one-pedal mode, the brake force to decelerate the vehicle is increased with a reduction in an operating amount of the accelerator pedal 2. Specifically, the brake force includes a brake force derived from a regenerative torque of the motor, and a brake force established by actuating the brake device. Given that an internal combustion engine is adopted as the prime mover, the brake force further includes an engine braking force established by the engine. Those brake forces are controlled cooperatively in such a manner as to achieve a required brake force. For example, in the one-pedal mode, the brake force greater than the engine braking force may be applied to the vehicle so as to decelerate or stop the vehicle.

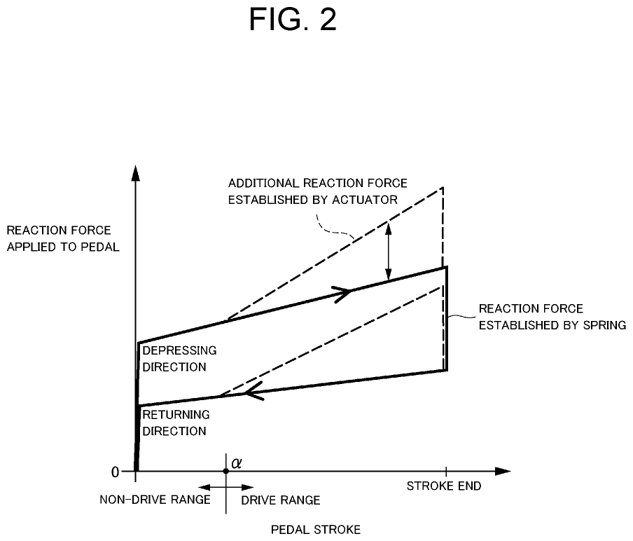

Characteristics of the reaction force in the one-pedal mode are indicated in FIG. 2, in which the solid line represents the reaction force established by the return spring, and the dashed line represents the additional reaction force established by the reaction force generating mechanism 6. In FIG. 2, the vertical axis represents a reaction force applied to the accelerator pedal 2, the horizontal axis represents a stroke (or a position) of the accelerator pedal 2, and a predetermined stroke position α is a boundary range (or the reference range) or a boundary point (i.e., a zero-torque point) between the decelerating range and the accelerating range. In addition, a range of vehicle behavior is indicated on the horizontal axis, and the range of vehicle behavior is divided into a non-drive range (i.e., the decelerating range) and a drive range across the stroke position α.

As described, according to the embodiment of the present invention, the operating mode may be shifted between the one-pedal mode and the normal mode by manipulating the operating switch. In the one-pedal mode, the range of movement of the accelerator pedal 2 is divided into the decelerating range and the accelerating range. Therefore, the characteristics of the reaction force in the one-pedal mode are different from those in the normal mode. For example, if the operating mode is shifted from the one-pedal mode to the normal mode while keeping the position of the accelerator pedal 2 within the accelerating range, the position of the accelerator pedal 2 within the range of movement in the normal mode would be too deep thereby increasing the drive force unintentionally. According to the embodiment of the present invention, in order not to disturb the driver 3, the control system is configured to prevent such unintentional increase in the drive force when shifting the operating mode between the one-pedal mode and the normal mode. In addition, the control system is further configured to adjust the position of the accelerator pedal 2 in accordance with an actual acceleration or a deceleration of the vehicle governed by a road gradient or the like, when shifting the operating mode between the one pedal mode and the normal mode. Hereinafter, a control example executed by the controller 8 will be explained.

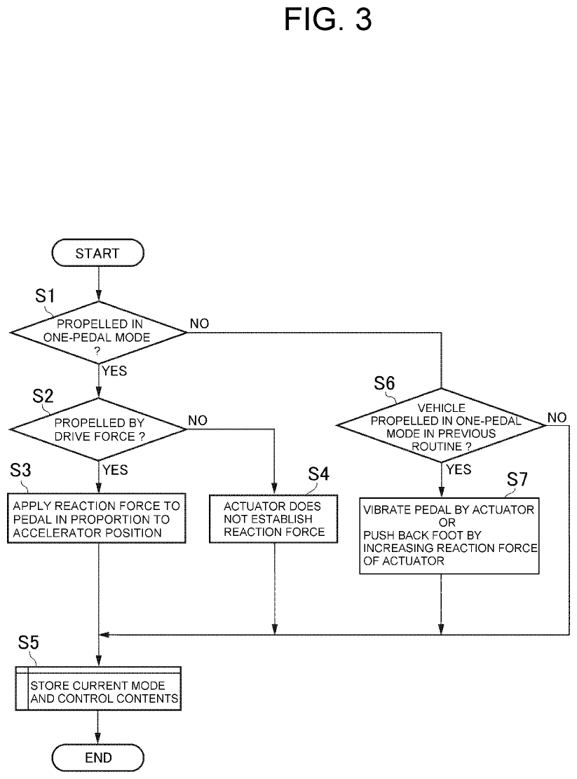

Specifically, the controller 8 executes a routine shown in FIG. 3. At step S1, it is determined whether the vehicle is propelled in the one-pedal mode. For example, such determination at step S1 may be made based on a fact that the operating switch for establishing the one-pedal mode is turned on. If the vehicle is propelled in the one-pedal mode so that the answer of step S1 is YES, the routine progresses to step S2 to determine whether the vehicle is propelled by the drive force.

As described, in the one-pedal mode, the range of movement of the accelerator pedal 2 is divided into the decelerating range and the accelerating range. Therefore, even when the vehicle travels on a sloping road in the one-pedal mode, the vehicle is decelerated or accelerated based only on a position of the accelerator pedal 2. In this situation, the actual acceleration or deceleration may not be controlled as intended and hence the driver 3 may be disturbed. At step S2, therefore, it is determined whether the vehicle is currently propelled by the drive force or decelerated by the brake force. Specifically, such determination is made taking account of a road gradient θ, the number of passenger(s), a control delay and so on.

If the vehicle is currently propelled by the drive force so that the answer of step S2 is YES, the routine progresses to step S3 to apply the reaction force to the accelerator pedal 2 by the reaction force generating mechanism (i.e., the actuator) 6 in proportion to the position of the accelerator pedal 2. Specifically, as indicated in FIG. 2, the reaction force applied to the accelerator pedal 2 is increased lineally in proportion to an increase in the actual acceleration of the vehicle. In this situation, according to the prior art, the reaction force applied to the accelerator pedal is increased instantaneously or stepwise. On the other hand, according to the embodiment of the present invention, the reaction force applied to the accelerator pedal 2 is increased gradually so that the driver 3 is allowed to recognize a fact that the vehicle is currently being accelerated.

By contrast, if the vehicle is currently decelerated by the brake force so that the answer of step S2 is NO, the routine progresses to step S4. In this case, the reaction force generating mechanism (i.e., the actuator) 6 does not establish the reaction force, and only the reaction force established by the return spring indicated by the dashed line is applied to the accelerator pedal 2. Thus, in the case that vehicle is not driven (or braked), the reaction force will not be changed by the reaction force generating mechanism 6 so that the driver 3 is allowed to recognize a fact that the vehicle is currently being decelerated.

After controlling the reaction force by the above-explained procedures, the routine progresses to step S5 to store control contents at step S3 or S4 and the current operating mode (i.e., the one-pedal mode), and thereafter returns.

Whereas, if the vehicle is not propelled in the one pedal mode so that the answer of step S1 is NO, the routine progresses to step S6 to determine whether the vehicle was propelled in the one-pedal mode in the previous routine. In this case, since the answer of step S1 is NO, it is possible to determine that the vehicle is currently propelled in the normal mode. However, it is still unknown whether the vehicle was propelled in the one-pedal mode in the previous routine and the operating mode was shifted in the current routine, or the vehicle has already been propelled in the normal mode in the previous routine. At step S6, therefore, it is determined whether the normal mode is selected in the current routine. As described, the operating mode may be shifted between the one-pedal mode and the normal mode by manipulating the operating switch.

If the vehicle was propelled in the one-pedal mode in the previous routine and the operating mode was shifted to the normal mode in the current routine so that the answer of step S6 is YES, the routine progresses to step S7 to vibrate the accelerator pedal 2, or to increase the reaction force applied to the accelerator pedal 2 by the reaction force generating mechanism 6. In a case of vibrating the accelerator pedal 2, specifically, the reaction force applied to the accelerator pedal 2 is increased and reduced repeatedly within a predetermined short period of time thereby notifying the fact that the operating mode has been shifted from the one-pedal mode to the normal mode. That is, the driver 3 is notified of the change in the operating mode through the vibrations of the accelerator pedal 2.

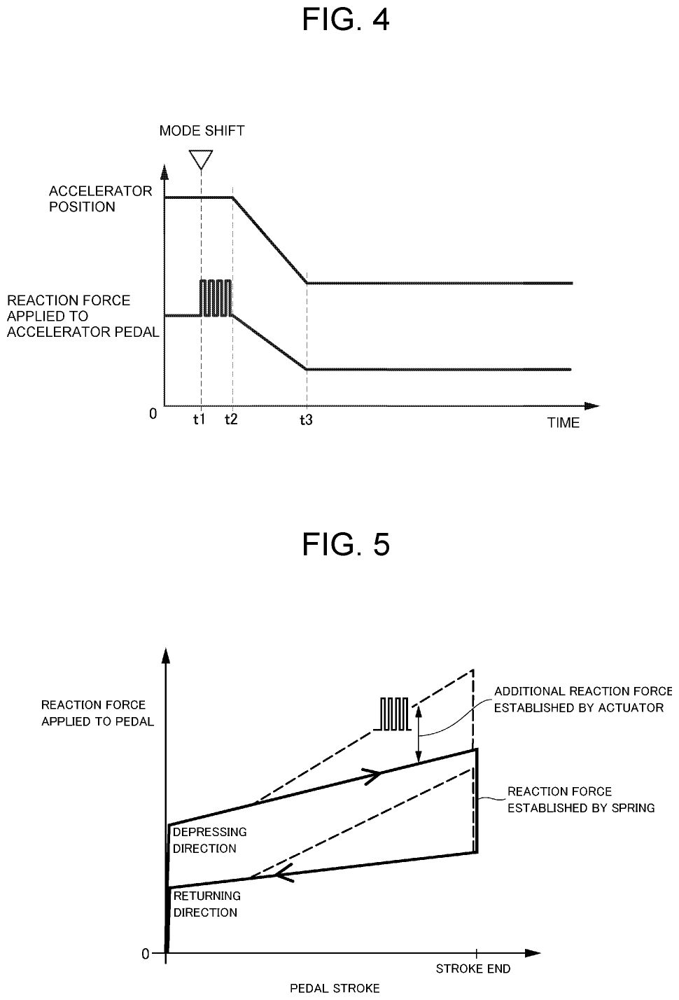

One example of temporal changes in the position of the accelerator pedal 2 and the reaction force applied to the accelerator pedal 2 are shown in FIG. 4. When the operating mode is shifted from the one-pedal mode to the normal mode at point t1, the reaction force applied to the accelerator pedal 2 is increased and reduced repeatedly to vibrate the accelerator pedal 2. Consequently, the driver 3 is notified of a fact that the operating mode has been shifted from the one-pedal mode to the normal mode by the vibrations of the accelerator pedal 2. As a result, the driver 3 lifts his/her foot off the accelerator pedal 2 or reduces the pedal force applied to the accelerator pedal 2 so that the accelerator pedal 2 is returned from point t2, and at the same time, the reaction force applied to the accelerator pedal 2 is reduced from point t2. In this situation, it is preferable to vibrate the accelerator pedal 2 at a magnitude sufficient to urge the driver 3 to lift his/her foot off the accelerator pedal 2 completely. In other words, the reaction force is applied to the accelerator pedal 2 at a magnitude that the driver 3 recognize the mode change and returns the accelerator pedal 2. Eventually, when the accelerator pedal 2 is stopped at an intended degree at point t3, the reaction force applied to the accelerator pedal 2 is reduced to a magnitude suitable to be applied to the accelerator pedal 2 at the intended degree in the normal mode. Characteristics of the reaction force thus vibrated is shown in FIG. 5. In this case, as described above, the reaction force applied to the accelerator pedal 2 is increased and reduced repeatedly by the reaction force generating mechanism 6.

Here will be explained the increasing control of the reaction force applied to the accelerator pedal 2 by the reaction force generating mechanism 6 executed at step S7. At step S7, the foot of the driver 3 put on the accelerator pedal 2 is pushed back toward the idle position by the reaction force generating mechanism 6 so that the driver 3 is urged to lift his/her foot off the accelerator pedal 2. Specifically, the reaction force applied to the accelerator pedal 2 is increased temporarily for a predetermined period of time to urge the driver 3 to lift his/her foot off the accelerator pedal 2, and thereafter reduced to a magnitude in accordance with a position of the accelerator pedal in the normal mode.

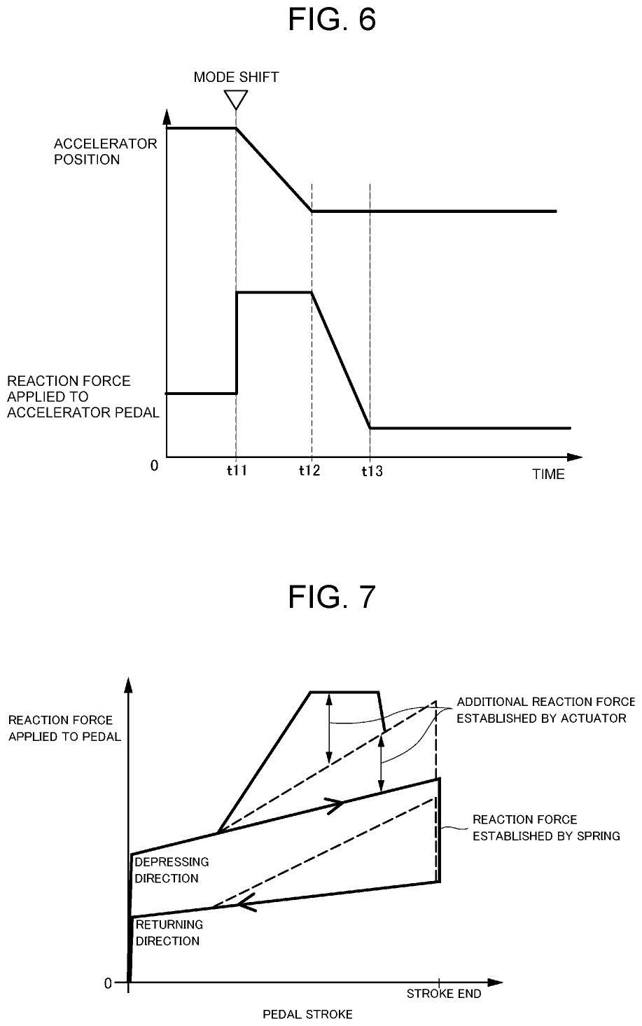

Turning to FIG. 6, there are shown one example of temporal changes in the position of the accelerator pedal 2 and the reaction force applied to the accelerator pedal 2 in the case of temporarily increasing the reaction force applied to the accelerator pedal 2. When the operating mode is shifted from the one-pedal mode to the normal mode at point t11, the reaction force applied to the accelerator pedal 2 is increased temporarily to point t12. Consequently, the driver 3 lifts his/her foot off the accelerator pedal 2 so that the accelerator pedal 2 is returned. In this situation, it is preferable to increase the reaction force applied to the accelerator pedal 2 to a magnitude that the driver 3 lifts his/her foot off the accelerator pedal 2 temporarily and completely. In other words, the reaction force is increased to a magnitude that the driver 3 recognizes the fact that the operating mode has been shifted from the one-pedal mode to the normal mode, and returns the accelerator pedal 2 temporarily. As a result, the accelerator pedal 2 is returned to a predetermined position at point t12, and the reaction force applied to the accelerator pedal 2 is reduced from point t12. Eventually, the reaction force applied to the accelerator pedal 2 is reduced to a magnitude suitable to be applied to the accelerator pedal 2 at the predetermined position in the normal mode. Turning to FIG. 7, there are shown characteristics of the reaction force thus increased to push back the foot of the driver 3 on the accelerator pedal 2 and to urge the driver 3 to lift his/her foot off the accelerator pedal 2. In this case, as described above, the reaction force applied to the accelerator pedal 2 is increased for a predetermined period of time by the reaction force generating mechanism 6 so that the driver 3 is notified of the face that the operating mode has been shifted from the one-pedal mode to the normal mode.

Here, in the event of mode change from the one-pedal mode to the normal mode, the controls to vibrate the accelerator pedal 2 and to increase the reaction force temporarily may be executed in any of the cases in which the accelerator pedal 2 is positioned in the accelerating range and in which the accelerator pedal 2 is positioned in the decelerating range. That is, in the event of mode change, the accelerator pedal 2 will be vibrated or the reaction force will be increased temporarily to urge the driver 3 to lift his/her foot off the accelerator pedal 2, irrespective of a position of the accelerator pedal 2. Consequently, the driver 3 is notified of execution of the mode change. In addition, when shifting the operating mode from the one-pedal mode to the normal mode, an increasing amount of the reaction force applied to the accelerator pedal 2 may be altered in individual cases in which the accelerator pedal 2 is positioned in the accelerating range, and in which the accelerator pedal 2 is positioned in the decelerating range.

After controlling the reaction force by the above-explained procedures at step S7, the routine progresses to step S5 to store control contents at step S7 and the current operating mode (i.e., the normal mode), and thereafter returns. Likewise, if the vehicle was not propelled in the one-pedal mode in the previous routine (that is, the normal mode has already been selected) so that the answer of step S6 is NO, the routine also progresses to step S5, and thereafter returns.

Thus, according to the embodiment of the present invention, the accelerator pedal 2 is vibrated by the reaction force generating mechanism 6 when shifting the operating mode from the one-pedal mode to the normal mode. Otherwise, the reaction force applied to the accelerator pedal 2 is increased temporarily to push back the foot of the driver 3 on the accelerator pedal 2 toward the idle position and to urge the driver 3 to lift his/her foot off the accelerator pedal 2. That is, the driver 3 is notified of the fact that the operating mode has been shifted from the one-pedal mode to the normal mode. For this reason, the driver 3 is allowed to certainly recognize the fact that the operating mode has been shifted from the one-pedal mode to the normal mode. That is, the driver 3 is physically notified of the execution of the mode change by the vibrations of the accelerator pedal 2 or the change in the reaction force applied to the accelerator pedal 2. Therefore, the driver 3 is allowed to sense a transmission of the notification more certainly compared to the case of notifying the driver 3 acoustically or visually as taught by Patent Document 1. For example, if external noise is too loud or if the driver has a conversation while driving, the driver may not perceive the phonic notification of the mode change. Otherwise, the driver may not be allowed to look at the text message indicated on the display of the navigation system depending on a travelling condition. Whereas, according to the embodiment of the present invention, the notification is transmitted physically to the foot of the driver 3 through the reaction force applied to the accelerator pedal 2. Therefore, the driver 3 can be notified of the fact that the operating mode has been shifted from the one-pedal mode to the normal mode even if the external noise is too loud or even if the driver 3 is not allowed to look at the display.

In addition, since the driver 3 can be certainly notified of the execution of the mode change, the driver 3 will not depress the accelerator pedal 2 unnecessarily deeply after shifting the operating mode. That is, the drive force established with respect to a predetermined operating amount of the accelerator pedal 2 is changed between the one-pedal mode and the normal mode. Therefore, if the foregoing controls are not executed, the driver 3 may depress the accelerator pedal 2 unnecessarily deeply after shifting the operating mode. Whereas, according to the embodiment of the present invention, the reaction force applied to the accelerator pedal 2 is temporarily increased or the accelerator pedal 2 is vibrated at step S7 to urge the driver 3 to lift his/her foot off the accelerator pedal 2. Therefore, the driver 3 is certainly notified of the fact that the operating mode has been shifted by the vibration of the accelerator pedal 2 or the increased reaction force applied to the accelerator pedal 2. For this reason, the driver 3 is allowed to operate the accelerator pedal 2 properly without depressing the accelerator pedal 2 unnecessarily deeply. Since the accelerator pedal 2 will not be unnecessarily deeply, the drive force can be generated in line with the intension of the driver 3. For this reason, the driver 3 can be prevented from being upset and disturbed.

Further, since the driver 3 is urged to lift his/her foot off the accelerator pedal 2, a position of the accelerator pedal 2 can be adjusted to an appropriate position in the normal mode. Therefore, when the driver 3 puts his/her foot on the accelerator pedal 2 again, the driver 3 is allowed to operate the accelerator pedal without being disturbed.

Furthermore, the control system according to the embodiment of the present invention is configured to determine whether the vehicle is propelled by the drive force during propulsion in the one-pedal mode, and to increase the reaction force applied to the accelerator pedal 2 in accordance with a position of the accelerator pedal 2. Specifically, in the case that the vehicle is propelled by the drive force, as indicated by the dashed line in FIG. 2, the reaction force applied to the accelerator pedal 2 is increased gradually by the reaction force generating mechanism 6. By contrast, in the case that the vehicle is decelerated by the brake force, only the reaction force established by the return spring is applied to the accelerator pedal (as indicated by the solid line). Thus, if the vehicle is propelled by the drive force, the reaction force applied to the accelerator pedal 2 is increased by the reaction force generating mechanism 6. Therefore, the driver 3 is allowed to certainly recognize the boundary between the decelerating range and the accelerating range. For this reason, the driver 3 is allowed to operate the accelerator pedal 2 properly in accordance with an actual acceleration or a deceleration of the vehicle without being upset and disturbed during propulsion in the one-pedal mode.

Although the above exemplary embodiments of the present invention have been described, the present invention should not be limited to the described exemplary embodiments, and various modifications can be made to achieve the objective of the present invention. In the foregoing embodiment, the reaction force is controlled at step S7 in the case that the operating mode is shifted from the one-pedal mode to the normal mode. However, the control system may control the reaction force also in the case that the operating mode is shifted from the normal mode to the one-pedal mode. In this case, the driver 3 is allowed to recognize a lack of depression of the accelerator pedal 2 when the operating mode is shifted from the normal mode to the one-pedal mode. In other words, the driver 3 is allowed to operate the accelerator pedal 2 properly to establish a desired drive force.

In addition, although the accelerator pedal 2 shown in FIG. 1 is suspended from the shaft, the control system may also be applied to a conventional standing accelerator pedal.

### REFERENCE SIGNS LIST

1: accelerator mechanism; 2: accelerator pedal; 3: driver; 4: pedal pad; 5: pedal arm; 6: reaction force generating mechanism; 7: accelerator position sensor; 8: controller (ECU); 9: shaft.

1. A reaction force control system for a pedal comprising:
an accelerator pedal of a vehicle that is operated by a driver;
a brake pedal that is operated by the driver; and
a reaction force generating mechanism that applies a reaction force to the accelerator pedal against a pedal force applied to the accelerator pedal, and that changes the reaction force,
wherein the reaction force control system is configured to select an operating mode from
a one-pedal mode in which not only a drive force but also a brake force are controlled by manipulating the accelerator pedal, and
a normal mode in which the drive force is controlled by manipulating the accelerator pedal, and the brake force is controlled by manipulating the brake pedal,
the reaction force control system comprises a controller that controls the reaction force applied to the accelerator pedal,
the controller is configured to
increase the reaction force applied to the accelerator pedal for a predetermined period of time when shifting the operating mode from one of the one-pedal mode and the normal mode to the other one of the operating modes, and thereafter adjust the reaction force in accordance with a position of the accelerator pedal in the other one of the operating modes, and
increase the reaction force applied to the accelerator pedal for the predetermined period of time, and thereafter reduce the reaction force gradually in accordance with the position of the accelerator pedal in the other one of the operating modes.

2. (canceled)

3. The reaction force control system as claimed in claim 1, wherein the controller is further is configured to increase and reduce the reaction force repeatedly thereby vibrating the accelerator pedal.

4. The reaction force control system as claimed in claim 3, wherein the reaction force is controlled to vibrate the accelerator pedal at a magnitude sufficient to urge the driver to lift his/her foot off the accelerator pedal.

5. The reaction force control system as claimed in claim 1, wherein the controller is further configured to increase the reaction force to push back the foot of the driver on the accelerator pedal toward an idle position so as to urge the driver to lift his/her foot off the accelerator pedal, when increasing the reaction force for the predetermined period of time in the event of a mode change from the one-pedal mode to the normal mode.
